(19) United States
(12) Patent Application Publication
(10) Pub. No.: US 2026/0286575 A1
(43) Pub. Date: Sep. 24, 2026

(54) CARBON FIBER PRECURSOR FIBER BUNDLE, THERMALLY-STABILIZED FIBER BUNDLE, PRODUCTION METHOD THEREOF, AND METHOD FOR PRODUCING CARBON FIBER BUNDLE

(71) Applicants: KABUSHIKI KAISHA TOYOTA CHUO KENKYUSHO, Nagakute-shi (JP); TOYOTA JIDOSHA KABUSHIKI KAISHA, Toyota-shi (JP)

(72) Inventors: Takuya MORISHITA, Nagakute-shi (JP); Mamiko NARITA, Nagakute-shi (JP); Mitsumasa MATSUSHITA, Nagakute-shi (JP); Hideyasu KAWAI, Toyota-shi (JP); Nozomu SHIGEMITSU, Toyota-shi (JP)

(73) Assignees: KABUSHIKI KAISHA TOYOTA CHUO KENKYUSHO, Nagakute-shi (JP); TOYOTA JIDOSHA KABUSHIKI KAISHA, Toyota-shi (JP)

(21) Appl. No.: 19/683,896

(22) Filed: May 21, 2026

Related U.S. Application Data
(62) Division of application No. 17/398,191, filed on Aug. 10, 2021.

(30) Foreign Application Priority Data
Nov. 27, 2020 (JP) 2020-197248

(51) Int. Cl. D01F 9/21; C08F 20/56; D01D 5/12; D01F 6/28

(52) U.S. Cl. CPC D01F 9/21; C08F 20/56; D01D 5/12; D01F 6/28; D10B 2401/063

(57) ABSTRACT

A carbon fiber precursor fiber bundle includes: acrylamide-based polymer fibers, wherein the carbon fiber precursor fiber bundle contains single fibers having a circular cross section in a proportion of 30 to 100%, wherein the circular cross section has a ratio of a major axis to a minor axis of 1.0 to 1.3 in a cross section orthogonal to a longitudinal direction of the single fiber, and a fineness of the single fiber is 0.1 to 7 dtex.

### BACKGROUND OF THE INVENTION

### Field of the Invention

The present invention relates to a carbon fiber precursor fiber bundle, a thermally-stabilized (flameproofed) fiber bundle, a production method thereof, and a method for producing a carbon fiber bundle.

### Related Background Art

As a conventional method for producing a carbon fiber, a method including thermally-stabilizing (flameproofing) a carbon fiber precursor, which is obtained by spinning polyacrylonitrile, and then carbonizing the carbon fiber precursor has mainly been employed (for example, Japanese Examined Patent Application Publication No. Sho37-4405 (PTL 1), Japanese Unexamined Patent Application Publication No. 2015-74844 (PTL 2), Japanese Unexamined Patent Application Publication No. 2016-40419 (PTL 3), and Japanese Unexamined Patent Application Publication No. 2016-113726 (PTL 4)). Since polyacrylonitrile, which is used in this method, is unlikely to be dissolved in an inexpensive general-purpose solvent, it is necessary to use an expensive solvent such as dimethyl sulfoxide or N,N-dimethylacetamide in polymerization and spinning, which brings about a problem of high production costs of carbon fibers.

In addition, Japanese Unexamined Patent Application Publication No. 2013-103992 (PTL 5) describes a carbon material precursor fiber which contains a polyacrylonitrile-based copolymer composed of 96 to 97.5 parts by mass of an acrylonitrile unit, 2.5 to 4 parts by mass of an acrylamide unit, and 0.01 to 0.5 parts by mass of a carboxylic acid-containing vinyl monomer. This polyacrylonitrile-based copolymer contains acrylamide units and carboxylic acid-containing vinyl monomer units that contribute to the water solubility of the polymer, but is insoluble in water because the contents thereof are low, and it is necessary to use an expensive solvent such as N,N-dimethylacetamide in the polymerization and molding process (spinning), and there is a problem that the production cost of carbon fiber becomes high.

There is also a problem that when polyacrylonitrile or a copolymer thereof is subjected to heating treatment, rapid heat generation occurs and accelerates the thermal decomposition of the polyacrylonitrile or the copolymer thereof, so that the yield of the carbon material (carbon fiber) is lowered. Therefore, when a carbon material (carbon fiber) is produced using polyacrylonitrile or a copolymer thereof, it is necessary to gradually raise the temperature over a long period of time so as not to cause rapid heat generation in the process of raising the temperature in the thermally-stabilizing treatment or the carbonizing treatment.

On the other hand, acrylamide-based polymers containing a large amount of acrylamide units are water-soluble polymers and allow water to be used as a solvent, which is inexpensive and has a small environmental load, during polymerization and molding process (such as film formation, sheet formation, and spinning), and thus it is expected to reduce the production cost of carbon materials. For example, Japanese Unexamined Patent Application Publication No. 2018-90791 (PTL 6) describes a carbon material precursor composition containing an acrylamide-based polymer and at least one additive selected from the group consisting of acids and salts thereof, and a method for producing a carbon material using the same. In addition, Japanese Unexamined Patent Application Publication No. 2019-26827 (PTL 7) describes a carbon material precursor which is composed of an acrylamide/vinyl cyanide-based copolymer containing 50 to 99.9 mol % of an acrylamide-based monomer unit and 0.1 to 50 mol % of a vinyl cyanide-based monomer unit, a carbon material precursor composition which contains this carbon material precursor and at least one additive selected from the group consisting of acids and salts thereof, and a method for producing a carbon material using these.

In addition, Japanese Unexamined Patent Application Publication No. 2011-202336 (PTL 8) states that a coagulated yarn obtained by spinning an acrylonitrile-based polymer is primarily drawn at a draw ratio of 1.1 to 5 at a temperature of 20 to 98° C. in order to obtain a precursor fiber having a dense and smooth surface, and further, the obtained yarn bundle is dried and then secondarily drawn in order to improve the denseness of the precursor fiber. Moreover, PTL 8 also states that when the precursor fiber bundle is subjected to thermally-stabilizing treatment, the elastic modulus of the obtained carbon fiber is improved by drawing at a draw ratio of 0.85 to 1.10.

### SUMMARY OF THE INVENTION

However, in the conventional methods for producing a carbon fiber bundle, even when the carbon fiber precursor fiber bundle is subjected to the thermally-stabilizing treatment, the fiber strength is not always sufficiently improved, and the yarn breakage may occur during the thermally-stabilizing treatment. Further, the tensile modulus of the obtained carbon fiber bundle is not always sufficiently high.

The present invention has been made in view of the above-mentioned problems of the related art, and an object thereof is to provide a carbon fiber precursor fiber bundle and a method for producing the same, in which the fiber strength is sufficiently improved by thermally-stabilizing treatment and the occurrence of yarn breakage during the thermally-stabilizing treatment is suppressed, a thermally-stabilized fiber which makes it possible to obtain a carbon fiber bundle having a high tensile modulus and a method for producing the same, and a method for producing a carbon fiber bundle having such a high tensile modulus.

The present inventors have made earnest studies to achieve the above objects and have found as a result the following. In the conventional carbon fiber precursor fiber bundle composed of acrylamide-based polymer fibers, the cross-sectional shape of a single fiber tends to be a cross-sectional shape other than a circular shape such as an elliptical shape or a dog bone shape. Even when a single fiber having such a cross-sectional shape other than a circular shape is subjected to thermally-stabilizing treatment, oxygen and heat are not sufficiently transmitted to the center portion of the cross section of the single fiber, and the single fiber is not sufficiently thermally-stabilized. As a result, the fiber strength is not sufficiently improved, and yarn breakage due to friction or the like during the thermally-stabilizing treatment may occur. In addition, even when a single fiber having a cross-sectional shape other than a circular shape is subjected to thermally-stabilizing treatment and further to a carbonizing treatment, the center portion of the cross section of the single fiber is not sufficiently heated, and thus the tensile modulus of the carbon fiber bundle is not sufficiently improved.

In view of the above, the present inventors have made further earnest studies and have found as a result the following. When a fiber bundle composed of acrylamide-based polymer fibers is subjected to a drawing process under a specific temperature condition, the cross-sectional shape of a single fiber tends to be a circular shape. When a single fiber having such a circular cross-sectional shape is subjected to a thermally-stabilizing treatment, oxygen and heat are sufficiently transmitted to the center portion of the cross section of the single fiber, and the single fiber is sufficiently thermally-stabilized. As a result, the fiber strength is improved, and yarn breakage due to friction or the like during the thermally-stabilizing treatment is suppressed. In addition, when a single fiber having a circular cross-sectional shape is subjected to a thermally-stabilizing treatment and further to a carbonizing treatment, the center portion of the cross section of the single fiber is sufficiently heated, and thus the tensile modulus of the carbon fiber bundle is improved. Therefore, the present invention has been completed.

Specifically, a carbon fiber precursor fiber bundle of the present invention is a carbon fiber precursor fiber bundle comprising: acrylamide-based polymer fibers, wherein the carbon fiber precursor fiber bundle contains single fibers having a circular cross section in a proportion of 30 to 100%, wherein the circular cross section has a ratio of a major axis to a minor axis of 1.0 to 1.3 in a cross section orthogonal to a longitudinal direction of the single fiber, and a fineness of the single fiber is 0.1 to 7 dtex.

In addition, a thermally-stabilized fiber bundle of the present invention is a thermally-stabilized fiber bundle of acrylamide-based polymer fibers, wherein the thermally-stabilized fiber bundle contains single fibers having a circular cross section in a proportion of 30 to 100%, wherein the circular cross section has a ratio of a major axis to a minor axis of 1.0 to 1.3 in a cross section orthogonal to a longitudinal direction of the single fiber, and a fineness of the single fiber is 0.1 to 6 dtex.

Further, a method for producing a carbon fiber precursor fiber bundle of the present invention is a method comprising: subjecting a fiber bundle composed of acrylamide-based polymer fibers to a drawing process at a draw ratio of 1.3 to 100 at a temperature in a range of 225 to 320° C., to obtain the carbon fiber precursor fiber bundle of the present invention. In the method for producing a carbon fiber precursor fiber bundle of the present invention, the draw ratio is preferably 1.8 to 30.

In addition, a method for producing a thermally-stabilized fiber bundle of the present invention is a method comprising: subjecting the carbon fiber precursor fiber bundle of the present invention to a thermally-stabilizing treatment, to obtain the thermally-stabilized fiber bundle of the present invention.

Further, a method for producing a carbon fiber bundle of the present invention is a method comprising: subjecting the thermally-stabilized fiber bundle of the present invention to a carbonizing treatment.

Note that in the present invention, the “single fiber having a circular cross section” not only includes a single fiber having a circular cross section which has the ratio of the major axis to the minor axis of 1.0 (that is, a perfectly-circular cross section) in a cross section orthogonal to a longitudinal direction (hereinafter simply referred to as “cross section”) but also a single fiber having a circular cross section which has the ratio of the major axis to the minor axis of more than 1.0 and 1.3 or less (that is, a substantially-circular cross section) in the cross section.

The present invention makes it possible to obtain a carbon fiber precursor fiber bundle, in which the fiber strength is sufficiently improved by thermally-stabilizing treatment and the occurrence of yarn breakage during the thermally-stabilizing treatment is suppressed. In addition, when the carbon fiber precursor fiber bundle is subjected to thermally-stabilizing treatment and further carbonizing treatment, it is possible to obtain a carbon fiber bundle having a high tensile modulus.

### DETAILED DESCRIPTION OF THE PREFERRED EMBODIMENTS

Hereinafter, the present invention is described in detail with reference to preferred embodiments thereof.

A carbon fiber precursor fiber bundle of the present invention is a carbon fiber precursor fiber bundle comprising: acrylamide-based polymer fibers, wherein the carbon fiber precursor fiber bundle contains single fibers having a circular cross section in a proportion of 30 to 100%, wherein the circular cross section has a ratio of a major axis to a minor axis of 1.0 to 1.3 in a cross section orthogonal to a longitudinal direction of the single fiber, and a fineness of the single fiber is 0.1 to 7 dtex. The carbon fiber precursor fiber bundle of the present invention can be produced by subjecting a fiber bundle composed of acrylamide-based polymer fibers to a drawing process at a draw ratio of 1.3 to 100 at a temperature in a range of 225 to 320° C.

In addition, a thermally-stabilized fiber bundle of the present invention is a thermally-stabilized fiber bundle of acrylamide-based polymer fibers, wherein the thermally-stabilized fiber bundle contains single fibers having a circular cross section in a proportion of 30 to 100%, wherein the circular cross section has a ratio of a major axis to a minor axis of 1.0 to 1.3 in a cross section orthogonal to a longitudinal direction of the single fiber, and a fineness of the single fiber is 0.1 to 6 dtex. The thermally-stabilized fiber bundle of the present invention can be produced by subjecting the carbon fiber precursor fiber bundle of the present invention to a thermally-stabilizing treatment.

Further, when the thermally-stabilized fiber bundle of the present invention is subjected to carbonizing treatment, it is possible to obtain a carbon fiber bundle having a high tensile modulus.

First, the acrylamide-based polymer and the acrylamide-based polymer fiber used in the present invention are described.

### (Acrylamide-Based Polymer)

The acrylamide-based polymer used in the present invention may be a homopolymer of an acrylamide-based monomer or a copolymer of an acrylamide-based monomer and an additional polymerizable monomer, and a copolymer of an acrylamide-based monomer and an additional polymerizable monomer is preferable from the viewpoints that the proportion of single fibers having a circular cross-sectional shape in the carbon fiber precursor fiber bundle and the thermally-stabilized fiber bundle is increased, the tensile modulus of the carbon fiber bundle is improved, and the carbonization yield is improved.

From the viewpoint of improving the solubility of the copolymer in an aqueous solvent (water, alcohol, and the like, and a mixed solvent thereof) or a water-based mixture solvent (a mixed solvent of the aqueous solvent and an organic solvent (such as tetrahydrofuran)), the lower limit of the content of the acrylamide-based monomer units in the copolymer of an acrylamide-based monomer and an additional polymerizable monomer is preferably 50 mol % or more, more preferably 55 mol % or more, and particularly preferably 60 mol % or more. In addition, from the viewpoints that the proportion of single fibers having a circular cross-sectional shape in the carbon fiber precursor fiber bundle and the thermally-stabilized fiber bundle is increased, the tensile modulus of the carbon fiber bundle is improved, and the carbonization yield is improved, the upper limit of the content of the acrylamide-based monomer units is preferably 99.9 mol % or less, more preferably 99 mol % or less, further preferably 95 mol % or less, particularly preferably 90 mol % or less, and most preferably 85 mol % or less.

From the viewpoints that the proportion of single fibers having a circular cross-sectional shape in the carbon fiber precursor fiber bundle and the thermally-stabilized fiber bundle is increased, the tensile modulus of the carbon fiber bundle is improved, and the carbonization yield is improved, the lower limit of the content of the additional polymerizable monomer units in the copolymer of an acrylamide-based monomer and an additional polymerizable monomer is preferably 0.1 mol % or more, more preferably 1 mol % or more, further preferably 5 mol % or more, particularly preferably 10 mol % or more, and most preferably 15 mol % or more. In addition, from the viewpoint of improving the solubility of the copolymer in an aqueous solvent or a water-based mixture solvent, the upper limit of the content of the additional polymerizable monomer units is preferably 50 mol % or less, more preferably 45 mol % or less, and particularly preferably 40 mol % or less.

The acrylamide-based monomer includes, for example, acrylamide; N-alkylacrylamides such as N-methylacrylamide, N-ethylacrylamide, N-n-propylacrylamide, N-isopropylacrylamide, N-n-butylacrylamide, N-tert-butylacrylamide, and N-hexylacrylamide; N-cycloalkylacrylamides such as N-cyclohexylacrylamide; dialkylacrylamides such as N,N-dimethylacrylamide; dialkylaminoalkyl acrylamide such as dimethylaminoethyl acrylamide and dimethylaminopropyl acrylamide; hydroxyalkylacrylamides such as N-(hydroxymethyl) acrylamide and N-(hydroxyethyl) acrylamide; N-arylacrylamides such as N-phenylacrylamide; diacetone acrylamide; N,N′-alkylene bisacrylamide such as N,N′-methylene bisacrylamide; methacrylamide; N-alkyl methacrylamides such as N-methyl methacrylamide, N-ethyl methacrylamide, N-n-propyl methacrylamide, N-isopropyl methacrylamide, N-n-butyl methacrylamide, N-tert-butyl methacrylamide, and N-hexyl methacrylamide; N-cycloalkyl methacrylamides such as N-cyclohexyl methacrylamide; dialkyl methacrylamides such as N,N-dimethyl methacrylamide; dialkylaminoalkyl methacrylamides such as dimethylaminoethyl methacrylamide and dimethylaminopropyl methacrylamide; hydroxyalkyl methacrylamides such as N-(hydroxymethyl) methacrylamide and N-(hydroxyethyl) methacrylamide; N-arylmethacrylamide such as N-phenylmethacrylamide; diacetone methacrylamide; N,N′-alkylene bismethacrylamide such as N,N′-methylene bismethacrylamide; crotonamide; maleic acid monoamide; maleamide; fumaric acid monoamide; fumaramide; mesaconic amide; citraconic amide; itaconic acid monoamide; and itaconic diamide. One of these acrylamide-based monomers may be used solely or two or more of these may be used in combination. In addition, among these acrylamide-based monomers, acrylamide, N-alkylacrylamide, dialkylacrylamide, methacrylamide, N-alkyl methacrylamide, and dialkyl methacrylamide are preferable, and acrylamide is particularly preferable, from the viewpoint that these acrylamide-based monomers have high solubilities into the aqueous solvent or the water-based mixture solvent.

Examples of the additional polymerizable monomer include vinyl cyanide-based monomers, unsaturated carboxylic acids and salts thereof, unsaturated carboxylic acid anhydrides, unsaturated carboxylic acid esters, vinyl-based monomers, and olefin-based monomers. Examples of the vinyl cyanide-based monomers include acrylonitrile, methacrylonitrile, 2-hydroxyethylacrylonitrile, chloroacrylonitrile, chloromethylacrylonitrile, methoxyacrylonitrile, methoxymethylacrylonitrile, and vinylidene cyanide. Examples of the unsaturated carboxylic acids include acrylic acid, methacrylic acid, maleic acid, fumaric acid, itaconic acid, citraconic acid, mesaconic acid, crotonic acid, and isocrotonic acid, examples of the salt of the unsaturated carboxylic acids include metal salts of the unsaturated carboxylic acids (such as sodium salts and potassium salts), ammonium salts, and amine salts, examples of the unsaturated carboxylic acid anhydrides include maleic anhydride and itaconic anhydride, examples of the unsaturated carboxylic acid esters include methyl acrylate, methyl methacrylate, 2-hydroxyethyl acrylate, and 2-hydroxyethyl methacrylate, examples of the vinyl-based monomers include aromatic vinyl-based monomers such as styrene and α-methylstyrene, vinyl chloride, and vinyl alcohol, and examples of the olefin-based monomers include ethylene and propylene. These additional polymerizable monomers may be used alone or in combination of two or more kinds. In addition, among these additional polymerizable monomers, vinyl cyanide-based monomers are preferable, and acrylonitrile is particularly preferable from the viewpoint of improving the spinnability of the acrylamide-based polymer and the carbonization yield, unsaturated carboxylic acids and salts thereof are preferable from the viewpoint of improving the solubility of the copolymer in an aqueous solvent or a water-based mixture solvent, and unsaturated carboxylic acids and unsaturated carboxylic acid anhydrides are preferable, and acrylic acid, maleic acid, fumaric acid, itaconic acid, and maleic anhydride are more preferable from the viewpoint of improving the fusion prevention property of the carbon fiber precursor fiber bundle during the thermally-stabilizing treatment.

The upper limit of the weight average molecular weight of the acrylamide-based polymer used in the present invention is not particularly limited, but is usually 5,000,000 or less, and from the viewpoint of improving the spinnability of the acrylamide-based polymer, it is preferably 2,000,000 or less, more preferably 1,000,000 or less, further preferably 500,000 or less, even further preferably 300,000 or less, particularly preferably 200,000 or less, even particularly preferably 130,000 or less, and most preferably 100,000 or less. In addition, the lower limit of the weight average molecular weight of the acrylamide-based polymer is not particularly limited, but is usually 10,000 or more, and from the viewpoint of improving the strengths of the carbon fiber precursor fiber bundle, thermally-stabilized fiber bundle, and carbon fiber bundle, it is preferably 20,000 or more, more preferably 30,000 or more, and particularly preferably 40,000 or more. The weight average molecular weight of the acrylamide-based polymer is measured by using gel permeation chromatography.

In addition, the acrylamide-based polymer used in the present invention is preferably soluble in at least either of an aqueous solvent and a water-based mixture solvent. As a result, when spinning an acrylamide-based polymer, dry spinning, dry-wet spinning, wet spinning, or electrospinning using the aqueous solvent or the water-based mixture solvent becomes possible, and it is possible to safely produce a carbon fiber precursor fiber bundle, a thermally-stabilized fiber bundle, and a carbon fiber bundle at low cost. Further, when the acrylamide-based polymer is blended with an additive described later, wet mixing using the aqueous solvent or the water-based mixture solvent becomes possible, and it is possible to safely and uniformly mix the acrylamide-based polymer and the additive described later at low cost. Note that the content of the organic solvent in the water-based mixture solvent is not particularly limited as long as the acrylamide-based polymer insoluble or poorly soluble in the aqueous solvent is in such an amount that is becomes soluble when mixed with an organic solvent. Further, among the acrylamide-based polymers, from the viewpoint that it is possible to safely produce a carbon fiber precursor fiber bundle, a thermally-stabilized fiber bundle, and a carbon fiber bundle at a lower cost, an acrylamide-based polymer soluble in the aqueous solvent is preferable, and an acrylamide-based polymer soluble in water (water-soluble) is more preferable.

As a method for synthesizing such an acrylamide-based polymer, a method may be employed in which a publicly-known polymerization reaction such as radical polymerization, cationic polymerization, anionic polymerization, or living radical polymerization is performed by a polymerization method such as solution polymerization, suspension polymerization, precipitation polymerization, dispersion polymerization, or emulsion polymerization (for example, inverse emulsion polymerization). Among the above-described polymerization reactions, the radical polymerization is preferable from the viewpoint that this makes it possible to produce the acrylamide-based polymer at low costs. In addition, in a case of employing the solution polymerization, as the solvent, one in which monomers of raw materials and an obtained acrylamide-based polymer can be dissolved is preferably used. The aqueous solvent (water, alcohol, and the like, and a mixed solvent thereof) or the water-based mixture solvent (a mixed solvent of the aqueous solvent and an organic solvent (such as tetrahydrofuran)) is more preferably used, the aqueous solvent is particularly preferably used, and water is most preferably used, from the viewpoint that it allows the production safely at low costs.

In the radical polymerization, as a polymerization initiator, a conventionally publicly-known radical polymerization initiator such as azobisisobutyronitrile, benzoyl peroxide, 4,4′-azobis(4-cyanovaleric acid), ammonium persulfate, and potassium persulfate may be used. However, in a case where the aqueous solvent or the water-based mixture solvent is used as the solvent, a radical polymerization initiator that is soluble in the aqueous solvent or the water-based mixture solvent (preferably the aqueous solvent, and more preferably water) such as 4,4′-azobis(4-cyanovaleric acid), ammonium persulfate, and potassium persulfate is preferable. In addition, a conventionally publicly-known polymerization accelerator such as tetramethylethylenediamine and a molecular weight modifier such as alkyl mercaptans including n-dodecyl mercaptan are preferably used in place of or in addition to the polymerization initiator, and the polymerization initiator and the polymerization accelerator are preferably used together, and ammonium persulfate and tetramethylethylenediamine are particularly preferably used together, from the viewpoints of improving the spinnability of the acrylamide-based polymer and improving the solubility of the acrylamide-based polymer in the aqueous solvent or the water-based mixture solvent.

The temperature when adding the polymerization initiator is not particularly limited, but is preferably 35° C. or more, more preferably 40° C. or more, further preferably 45° C. or more, particularly preferably 50° C. or more, and most preferably 55° C. or more, from the viewpoint of improving the spinnability of the acrylamide-based polymer. In addition, the temperature of the polymerization reaction is not particularly limited, but is preferably 50° C. or more, more preferably 60° C. or more, and most preferably 70° C. or more, from the viewpoint of improving the solubility of the acrylamide-based polymer in the aqueous solvent or the water-based mixture solvent.

### (Acrylamide-Based Polymer Fiber)

The acrylamide-based polymer fiber used in the present invention is composed of the acrylamide-based polymer, and can be used as it is for producing a carbon fiber precursor fiber bundle, a thermally-stabilized fiber bundle, and a carbon fiber bundle without adding an additive such as an acid, but the acrylamide-based polymer fiber preferably contains at least one additive selected from the group consisting of acids and salts thereof, in addition to the acrylamide-based polymer, from the viewpoints that proportion of single fibers having a circular cross-sectional shape in the carbon fiber precursor fiber bundle and the thermally-stabilized fiber bundle is increased, the formation of a cyclic structure by dehydration reaction and deammoniation reaction is accelerated, the formation of a continuous polycyclic structure is accelerated to improve the tensile modulus of the thermally-stabilized fiber bundle and thus the fusion of the carbon fiber precursor fiber bundle during the thermally-stabilizing treatment is further suppressed, and the tensile modulus of the carbon fiber bundle is also improved. Further, when the carbon fiber precursor fiber bundle containing the additive is subjected to thermally-stabilizing treatment while applying tension, the formation of a cyclic structure by dehydration reaction and deammoniation reaction is accelerated, and the formation of a continuous polycyclic structure is accelerated, and as a result, a thermally-stabilized fiber bundle having excellent load resistance at high temperature, high strength, high elastic modulus, and high carbonization yield can be obtained. Further, in the thermally-stabilized fiber bundle and the carbon fiber bundle obtained by the present invention, at least a part of the additive and residues thereof may remain. In addition, the carbonizing treatment may be performed by adding the additive to the thermally-stabilized fiber bundle.

From the viewpoints that the proportion of single fibers having a circular cross-sectional shape in the carbon fiber precursor fiber bundle and the thermally-stabilized fiber bundle is increased, the fusion of the carbon fiber precursor fiber bundle during the thermally-stabilizing treatment is suppressed, the load resistance at high temperature, strength, elastic modulus, and carbonization yield of the thermally-stabilized fiber bundle are improved, and the tensile modulus of the carbon fiber bundle is improved, the content of the additive is preferably 0.05 to 100 parts by mass, more preferably 0.1 to 50 parts by mass, further preferably 0.3 to 30 parts by mass, particularly preferably 0.5 to 20 parts by mass, and most preferably 1.0 to 10 parts by mass, based on 100 parts by mass of the acrylamide-based polymer.

The acids include inorganic acids such as phosphoric acid, polyphosphoric acid, boric acid, polyboric acid, sulfuric acid, nitric acid, carbonic acid, and hydrochloric acid and organic acids such as oxalic acid, citric acid, sulfonic acid, and acetic acid. In addition, the salts of such acids include metal salts (for example, sodium salts and potassium salts), ammonium salts, amine salts, and the like. Ammonium salts and amine salts are preferable, and ammonium salts are more preferable. In particular, among these additives, phosphoric acid, polyphosphoric acid, boric acid, polyboric acid, and sulfuric acid and ammonium salts of these are preferable, and phosphoric acid and polyphosphoric acid, and ammonium salts of these are particularly preferable, from the viewpoints that proportion of single fibers having a circular cross-sectional shape in the carbon fiber precursor fiber bundle and the thermally-stabilized fiber bundle is increased, the load resistance at high temperature, strength, elastic modulus, and carbonization yield of the thermally-stabilized fiber are improved, and the tensile modulus of the carbon fiber bundle is improved.

In addition to the additives, the acrylamide-based polymer fiber may contain various fillers, including chlorides such as sodium chloride and zinc chloride, hydroxides such as sodium hydroxide, and nanocarbons such as carbon nanotubes and graphene, as long as the effects of the present invention are not impaired

The additive is preferably soluble in at least either of the aqueous solvent and the water-based mixture solvent (more preferably the aqueous solvent, and particularly preferably water). This makes it possible to perform wet mixing using the aqueous solvent or the water-based mixture solvent when producing the acrylamide-based polymer fiber, and thus makes it possible to safely and uniformly mix the acrylamide-based polymer and the additive at low costs. In addition, this makes it possible to perform dry spinning, dry-wet spinning, wet spinning, or electrospinning using the aqueous solvent or the water-based mixture solvent, and thus makes it possible to safely produce a carbon material at low costs.

Such an acrylamide-based polymer fiber can be prepared (produced) as follows. First, the acrylamide-based polymer or the acrylamide-based polymer composition containing the acrylamide-based polymer and the additive is spun. Here, the acrylamide-based polymer or acrylamide-based polymer composition in a molten state may be used for melt spinning, spun bonding, melt blowing, or centrifugal spinning, but when the acrylamide-based polymer or the acrylamide-based polymer composition is soluble in the aqueous solvent or the water-based mixture solvent, from the viewpoint of improving spinnability, it is preferable that the acrylamide-based polymer or the acrylamide-based polymer composition is dissolved in the aqueous solvent or the water-based mixture solvent and then the obtained aqueous solution or water-based mixed solution is used for spinning, or that the above-mentioned solution of the acrylamide-based polymer after the polymerization or the solution of the acrylamide-based polymer composition obtained by wet mixing described later is used as it is or adjusted to a desired concentration and then spun. As such a spinning method, dry spinning, wet spinning, dry-wet spinning, gel spinning, flash spinning, or electrospinning is preferable. This makes it possible to safely prepare (produce) an acrylamide-based polymer fiber having a desired fineness and average fiber diameter at low cost. In addition, the aqueous solvent is more preferably used, and water is particularly preferably used, as the solvent, from the viewpoint that an acrylamide-based polymer fiber can be more safely produced at lower costs.

In addition, the concentration of the acrylamide-based polymer in the aqueous solution or the water-based mixed solution is not particularly limited, but a high concentration of 20% by mass or more is preferable from the viewpoint of improving productivity and reducing costs. Note that when the concentration of the acrylamide-based polymer is too high, the viscosity of the aqueous solution or the water-based mixed solution becomes high, and the spinnability is lowered, and therefore it is preferable to adjust the concentration of the aqueous solution or the water-based mixed solution to a concentration at which spinning is possible using the viscosity as an index.

As a method for producing the acrylamide-based polymer composition, it is also possible to employ a method including directly mixing the additive with the acrylamide-based polymer in a molten state (melt mixing), a method including dry-blending the acrylamide-based polymer and the additive (dry mixing), and a method including impregnating or passing the acrylamide-based polymer formed in a fiber shape into an aqueous solution or a water-based mixed solution that contains the additive or a solution in which the acrylamide-based polymer has not been completely dissolved but the additive has been dissolved. In a case where the acrylamide-based polymer and the additive used are soluble in the aqueous solvent or the water-based mixture solvent, a method including mixing the acrylamide-based polymer and the additive in the aqueous solvent or the water-based mixture solvent (wet mixing) is preferable from the viewpoint that this method can mix the acrylamide-based polymer and the additive uniformly. In addition, as the wet mixing, in a case where the above-described polymerization has been performed in the aqueous solvent or in the water-based mixture solvent in synthesizing the acrylamide-based polymer, it is also possible to employ a method including mixing the additive after the polymerization or the like. Moreover, it is also possible to collect the acrylamide-based polymer composition by removing the solvent from the obtained solution, and use the collected acrylamide-based polymer composition in the production of an acrylamide-based polymer fiber. Furthermore, it is also possible to use the obtained solution as it is in the production of the acrylamide-based polymer fiber without removing the solvent. In addition, in the wet mixing, the aqueous solvent is preferably used, and water is more preferably used, as the solvent, from the viewpoint that the acrylamide-based polymer composition can be produced more safely at lower costs. Moreover, the method for removing the solvent is not particularly limited and at least one of publicly-known methods such as distillation under reduced pressure, re-precipitation, hot-air drying, vacuum-drying, and freeze drying may be employed.

In the present invention, such an acrylamide-based polymer fiber is used as a fiber bundle. The number of filaments per thread in the fiber bundle composed of acrylamide-based polymer fibers is not particularly limited, but is preferably 50 to 96000, more preferably 100 to 48000, further preferably 500 to 36000, and particularly preferably 1000 to 24000, from the viewpoint of improving the high productivity and mechanical properties of the thermally-stabilized fiber bundle and the carbon fiber bundle. If the number of filaments per thread exceeds the upper limit, uneven firing may occur during the thermally-stabilizing treatment.

### [Carbon Fiber Precursor Fiber Bundle and Production Method Thereof]

Next, the carbon fiber precursor fiber bundle of the present invention and a method for producing the same are described. The carbon fiber precursor fiber bundle of the present invention is obtained by subjecting a fiber bundle composed of the acrylamide-based polymer fibers to a drawing process under a specific temperature condition, and is a carbon fiber precursor fiber bundle composed of the acrylamide-based polymer fibers.

In the method for producing a carbon fiber precursor fiber bundle of the present invention, it is necessary that the temperature (maximum temperature) during the drawing process is in the range of 225 to 320° C. When the maximum temperature during the drawing process is within the above range, a carbon fiber precursor fiber bundle is obtained in which yarn breakage is unlikely to occur during the drawing process, the proportion of single fibers having a circular cross-sectional shape is large, the fiber strength is improved by thermally-stabilizing treatment, and yarn breakage due to friction or the like during the thermally-stabilizing treatment is suppressed. In contrast, if the maximum temperature during the drawing process becomes less than the lower limit, yarn breakage occurs during the drawing process, the proportion of single fibers having a circular cross-sectional shape is small in the obtained carbon fiber precursor fiber bundle, the fiber strength is not sufficiently improved even when thermally-stabilizing treatment is applied, and yarn breakage due to friction or the like during the thermally-stabilizing treatment occurs. On the other hand, if the maximum temperature during the drawing process exceeds the upper limit, fusion of the acrylamide-based polymer fibers may occur. In addition, the temperature (maximum temperature) during the drawing process is preferably 225 to 300° C., more preferably 230 to 295° C., further preferably 235 to 290° C., particularly preferably 240 to 285° C., and most preferably 245 to 280° C., from the viewpoint that a carbon fiber precursor fiber bundle is obtained in which yarn breakage is further less likely to occur during the drawing process, the proportion of single fibers having a circular cross-sectional shape is further increased, the fiber strength is further improved by thermally-stabilizing treatment, and yarn breakage due to friction or the like during the thermally-stabilizing treatment is further suppressed.

In addition, in the method for producing a carbon fiber precursor fiber bundle of the present invention, it is necessary that the draw ratio during the drawing process is in the range of 1.3 to 100. When the draw ratio is within the above range, a carbon fiber precursor fiber bundle is obtained in which yarn breakage is unlikely to occur during the drawing process, the proportion of single fibers having a circular cross-sectional shape is large, the fiber strength is improved by thermally-stabilizing treatment, and yarn breakage due to friction or the like during the thermally-stabilizing treatment is suppressed. In contrast, if the draw ratio becomes less than the lower limit, the proportion of single fibers having a circular cross-sectional shape is small in the obtained carbon fiber precursor fiber bundle, the fiber strength is not sufficiently improved even when thermally-stabilizing treatment is applied, and yarn breakage due to friction or the like during the thermally-stabilizing treatment occurs. On the other hand, if the draw ratio exceeds the upper limit, yarn breakage occurs during the drawing process. In addition, the draw ratio is preferably 1.4 to 50, more preferably 1.5 to 40, further preferably 1.8 to 30, particularly preferably 2.0 to 20, and most preferably 3.0 to 10, from the viewpoint that a carbon fiber precursor fiber bundle is obtained in which yarn breakage is further less likely to occur during the drawing process, the proportion of single fibers having a circular cross-sectional shape is further increased, the fiber strength is further improved by thermally-stabilizing treatment, and yarn breakage due to friction or the like during the thermally-stabilizing treatment is further suppressed.

Note that such a draw ratio can be determined by the ratio (drawing speed/introducing speed) of the feeding speed (introducing speed) of the fiber bundle composed of the acrylamide-based polymer fibers introduced into the heating furnace or the like to the feeding speed (drawing speed) of the carbon fiber precursor fiber bundle drawn from the heating furnace or the like, or can also be determined by the ratio between the lengths of the fiber bundle composed of the acrylamide-based polymer fibers and the carbon fiber precursor fiber bundle (the length of the carbon fiber precursor fiber bundle/the length of the fiber bundle composed of an acrylamide-based polymer fibers). Such a draw ratio can be controlled by adjusting the ratio (drawing speed/introducing speed) between the feeding speeds of the fiber bundle composed of the acrylamide-based polymer fibers and the carbon fiber precursor fiber bundle as well as the tension applied to the fiber bundle, the temperature during the drawing process, the water content of the acrylamide-based polymer fiber, and the like. However, even when, for example, the temperature during the drawing process and the water content of the acrylamide-based polymer fiber are the same, the draw ratio changes depending on the composition of the acrylamide-based polymer, the presence or absence of the additive in the acrylamide-based polymer fiber, and the amount added thereof, and thus it is necessary to adjust to the desired draw ratio by adjusting the ratio (drawing speed/introducing speed) between the feeding speeds of the fiber bundle composed of the acrylamide-based polymer fibers and the carbon fiber precursor fiber bundle as well as the tension applied to the fiber bundle (controlled by a weight, a spring, and the like).

The method of drawing treatment is not particularly limited, but it is possible to employ a publicly-known drawing means such as a method including drawing in a gas phase heated to a predetermined temperature (for example, in a heating furnace (including a hot air furnace) containing air or an inert gas heated to a predetermined temperature) (air drawing process), a method including using a heated body such as a hot roller heated to a predetermined temperature (heat drawing process), and a method including drawing in a solvent heated to a predetermined temperature (wet drawing process). Among these drawing process methods, air drawing process and heat drawing process are preferable. In the case of the air drawing process, the drawing process may be performed in either an oxidizing gas atmosphere or an inert gas atmosphere, but from the viewpoint of convenience, it is preferably performed in an oxidizing gas atmosphere, particularly in air. Further, in the present invention, since the thermally-stabilizing treatment described later is performed after performing the drawing process, the drawing process and the thermally-stabilizing treatment may be continuously or simultaneously performed using a heating furnace for use in thermally-stabilizing treatment (thermally-stabilizing furnace). Further, the drawing process may be performed in one stage or in two or more stages.

As described above, in the present invention, when the fiber bundle composed of the acrylamide-based polymer fibers is subjected to drawing process at predetermined temperature (maximum temperature) and draw ratio, the carbon fiber precursor fiber bundle of the present invention is obtained containing single fibers having a circular cross section in a proportion in the range of 30 to 100%, wherein the circular cross section has a ratio of a major axis to a minor axis of 1.0 to 1.3 in a cross section orthogonal to a longitudinal direction of the single fiber, and a fineness of the single fiber is in the range of 0.1 to 7 dtex.

When the carbon fiber precursor fiber bundle in which the proportion of single fibers having a circular cross-sectional shape is in the above range is subjected to thermally-stabilizing treatment, a thermally-stabilized fiber bundle is obtained in which the fiber strength is improved, yarn breakage due to friction or the like during the thermally-stabilizing treatment is suppressed, and the proportion of single fibers having a circular cross-sectional shape is large. In contrast, even if the carbon fiber precursor fiber bundle in which the proportion of single fibers having a circular cross-sectional shape is less than the lower limit is subjected to thermally-stabilizing treatment, the fiber strength is not sufficiently improved, yarn breakage due to friction or the like during the thermally-stabilizing treatment occurs, the proportion of single fibers having a circular cross-sectional shape is small in the obtained thermally-stabilized fiber bundle, and the tensile modulus is not sufficiently improved even when carbonizing treatment is applied. In addition, the proportion of single fibers having a circular cross-sectional shape is preferably 35 to 100%, more preferably 40 to 100%, and particularly preferably 50 to 100%, from the viewpoint that a thermally-stabilized fiber bundle is obtained in which the fiber strength of the carbon fiber precursor fiber bundle is improved, yarn breakage due to friction or the like during the thermally-stabilizing treatment is suppressed, and the proportion of single fibers having a circular cross-sectional shape is large.

In addition, in the carbon fiber precursor fiber bundle, when the fineness of the single fiber is within the above range, the tensile strength and tensile modulus of the obtained thermally-stabilized fiber bundle are improved, yarn breakage during carbonizing treatment can be prevented, and the tensile modulus of the obtained carbon fiber bundle is improved. In contrast, if the fineness of the single fiber is less than the lower limit, yarn breakage is likely to occur, and stable winding and thermally-stabilizing treatment become difficult. On the other hand, if the fineness of the single fiber exceeds the upper limit, it becomes difficult to sufficiently make the single fiber thermally-stabilizing up to the center portion of the cross section, and the effect of improving the tensile modulus by drawing during the drawing process is reduced. In addition, the fineness of the single fiber is preferably 0.15 to 6 dtex, more preferably 0.2 to 5 dtex, and particularly preferably 0.25 to 4 dtex, from the viewpoints that the tensile strength and tensile modulus of the obtained thermally-stabilized fiber bundle are improved, yarn breakage during carbonizing treatment can be prevented, and the tensile modulus of the obtained carbon fiber bundle is improved.

Further, in the carbon fiber precursor fiber bundle of the present invention, the average fiber diameter of the single fiber is not particularly limited, but is preferably 1 to 80 μm, more preferably 2 to 50 μm, further preferably 3 to 40 μm, particularly preferably 4 to 30 μm, and most preferably 5 to 25 μm. If the average fiber diameter of the single fiber of the carbon fiber precursor fiber bundle is less than the lower limit, yarn breakage is likely to occur, and stable winding and thermally-stabilizing treatment tend to become difficult. On the other hand, if the average fiber diameter of the single fiber of the carbon fiber precursor fiber bundle exceeds the upper limit, in the obtained single fiber of the thermally-stabilized fiber bundle, the structure is significantly different between the vicinity of the surface layer and the vicinity of the center, and the tensile strength and tensile modulus of the obtained carbon fiber bundle tend to decrease.

In addition, a conventionally known oil agent such as a silicone-based oil agent may be adhered to the carbon fiber precursor fiber bundle from the viewpoints of fiber focusing, improved handling, and prevention of adhesion between fibers. The timing for adhering the oil agent may be any of that before the drawing process (that is, after adhering the oil agent to the fiber bundle composed of the acrylamide-based polymer, the drawing process is performed), that during the drawing process (that is, while performing the drawing process, the oil agent is adhered to the fiber bundle composed of the acrylamide-based polymer), and that after the drawing process (that is, after subjecting the fiber bundle composed of the acrylamide-based polymer to drawing process, the oil agent is adhered to the obtained carbon fiber precursor fiber bundle). The oil agent is preferably an oil agent having heat resistance (particularly, an oil agent which is hard to be thermally decomposed at a temperature of 300° C. or less), more preferably a silicone-based oil agent, and particularly preferably a modified silicone-based oil agent (for example, amino-modified silicone-based oil agents, epoxy-modified silicone-based oil agents, ether-modified silicone-based oil agents, and aryl-modified silicone-based oil agents such as methylphenyl silicone). These oil agents may be used alone or in combination of two or more kinds. In addition, the oil agent concentration in the oil agent bath used for adhering an oil agent is preferably 0.1 to 20% by mass, and more preferably 1 to 10% by mass. Further, the carbon fiber precursor fiber bundle to which the oil agent is adhered in this manner is dried at a temperature of preferably 50 to 250° C. (more preferably 100 to 200° C.). As a result, a dense carbon fiber precursor fiber bundle is obtained. The drying method is not particularly limited, and examples thereof include a drying method involving use of a heat roller whose surface temperature is heated to a temperature within the above range.

### [Thermally-Stabilized Fiber Bundle and Production Method Thereof]

Next, the thermally-stabilized fiber bundle of the present invention and a method for producing the same are described. The thermally-stabilized fiber bundle of the present invention is obtained by subjecting the carbon fiber precursor fiber bundle of the present invention to heating treatment (thermally-stabilizing treatment) in an oxidizing atmosphere (for example, in air), and is a thermally-stabilized fiber bundle of the acrylamide-based polymer fibers. The carbon fiber precursor fiber bundle contains the acrylamide-based polymer, is not easily thermally decomposed by thermally-stabilizing treatment, and exhibits a high carbonization yield because the structure of the acrylamide-based polymer is converted into a structure having high heat resistance by the thermally-stabilizing treatment. In particular, in the carbon fiber precursor fiber bundle containing the additive, the catalytic action of an acid or a salt thereof as the additive promotes the dehydration reaction and deammoniation reaction of the acrylamide-based polymer, and thus a cyclic structure (imide ring structure) is easily formed in the molecule, and the structure of the acrylamide-based polymer is easily converted into a structure having high heat resistance, so that the carbonization yield is further increased.

In the method for producing a thermally-stabilized fiber bundle of the present invention, the thermally-stabilizing treatment is not particularly limited, but is preferably performed at a temperature in the range of 200 to 500° C., more preferably performed at a temperature in the range of 270 to 450° C., further preferably performed at a temperature in the range of 300 to 430° C., and particularly preferably performed at a temperature in the range of 305 to 420° C. Note that the thermally-stabilizing treatment performed at such a temperature includes not only thermally-stabilizing treatment at the maximum temperature during the thermally-stabilizing treatment described later (thermally-stabilizing treatment temperature) but also thermally-stabilizing treatment in the process of raising the temperature to the thermally-stabilizing treatment temperature.

In addition, the maximum temperature during the thermally-stabilizing treatment (thermally-stabilizing treatment temperature) is preferably higher than the temperature during the drawing process (maximum temperature) and at 500° C. or less, more preferably 310 to 450° C., further preferably 320 to 440° C., particularly preferably 325 to 430° C., and most preferably 330 to 420° C. If the thermally-stabilizing treatment temperature is less than the lower limit, the dehydration reaction and deammoniation reaction of the acrylamide-based polymer are not promoted, and it is difficult to form a cyclic structure (imide ring structure) in the molecule, and thus the heat resistance of the thermally-stabilized fiber bundle produced tends to be low, and the carbonization yield tends to decrease. On the other hand, if the thermally-stabilizing treatment temperature exceeds the upper limit, the thermally-stabilized fiber bundle produced tends to be thermally decomposed.

The thermally-stabilizing treatment time (heating time at the maximum temperature) is not particularly limited, and heating for a long time (for example, more than 2 hours) is possible, but the time is preferably 1 to 120 minutes, more preferably 2 to 60 minutes, further preferably 3 to 50 minutes, and particularly preferably 4 to 40 minutes. The carbonization yield can be improved by setting the heating time during the thermally-stabilizing treatment to be equal to or greater than the lower limit, while the cost can be reduced by setting it to 2 hours or less.

Further, in the method for producing a thermally-stabilized fiber bundle of the present invention, it is preferable to perform the thermally-stabilizing treatment while or after applying tension to the carbon material precursor fiber bundle. This further improves the fusion prevention property of the carbon material precursor fiber bundle during the thermally-stabilizing treatment, and it is possible to obtain a thermally-stabilized fiber bundle having excellent load resistance at high temperature, high strength, high elastic modulus, and high carbonization yield. The tension applied to the thermally-stabilized fiber bundle is not particularly limited, but is preferably 0.007 to 30 mN/dtex, more preferably 0.010 to 20 mN/dtex, further preferably 0.020 to 5 mN/dtex, still further preferably 0.025 to 1.5 mN/dtex, particularly preferably 0.030 to 1 mN/dtex, and most preferably 0.035 to 0.5 mN/dtex. If the tension applied to the carbon material precursor fiber bundle is less than the lower limit, the fusion of the carbon material precursor fiber bundle during the thermally-stabilizing treatment is not sufficiently suppressed, and the load resistance at high temperature, strength, elastic modulus, and carbonization yield of the thermally-stabilized fiber bundle tend to decrease. On the other hand, if the tension applied to the carbon material precursor fiber bundle exceeds the upper limit, yarn breakage may occur during the thermally-stabilizing treatment. Note that in the present invention, the tension (unit: mN/dtex) applied to the carbon material precursor fiber bundle is a value obtained by dividing the tension (unit: mN) applied to the carbon material precursor fiber bundle by the fineness (unit: dtex) of the carbon material precursor fiber bundle in an absolute dry state, that is, the tension per unit fineness of the carbon material precursor fiber bundle. In addition, the tension applied to the carbon material precursor fiber bundle can be adjusted by a load cell, a spring, a weight, or the like on the inlet side, the outlet side, or the like of a heating device such as a thermally-stabilizing furnace.

Further, in the method for producing a thermally-stabilized fiber bundle of the present invention, when the carbon material precursor fiber bundle is subjected to thermally-stabilizing treatment while applying a predetermined tension, tension may or may not be applied in the process of raising the temperature to the thermally-stabilizing treatment temperature as long as a predetermined tension is applied to the carbon material precursor fiber at the thermally-stabilizing treatment temperature (maximum temperature during the thermally-stabilizing treatment), but it is preferable that tension is applied even in the temperature raising process or the like from the viewpoint that the effect of applying tension can be sufficiently obtained. In addition, the tension may be applied from an initial stage such as the temperature raising process, or may be applied from an intermediate stage.

In addition, in the method for producing a thermally-stabilized fiber bundle of the present invention, after heating treatment is performed while applying a predetermined tension at the thermally-stabilizing treatment temperature (maximum temperature during the thermally-stabilizing treatment), heating treatment may be performed at a temperature higher than the thermally-stabilizing treatment temperature with or without applying a tension other than the predetermined tension.

In the method for producing a thermally-stabilized fiber bundle of the present invention, thermally-stabilizing treatment may be performed while performing drawing process. The draw ratio during the thermally-stabilizing treatment is preferably 1.3 to 100, more preferably 1.7 to 50, further preferably 2.0 to 25, and particularly preferably 3.0 to 10. If the draw ratio during the thermally-stabilizing treatment is less than the lower limit, the fusion of the carbon material precursor fiber bundle during the thermally-stabilizing treatment is not sufficiently suppressed, and the load resistance at high temperature, strength, elastic modulus, and carbonization yield of the thermally-stabilized fiber bundle tend to decrease. On the other hand, if the draw ratio during the thermally-stabilizing treatment exceeds the upper limit, yarn breakage may occur during the thermally-stabilizing treatment.

Note that such a draw ratio can be determined by the ratio (drawing speed/introducing speed) of the feeding speed (introducing speed) of the carbon material precursor fiber bundle introduced into the heating furnace (thermally-stabilizing furnace) to the feeding speed (drawing speed) of the thermally-stabilized fiber bundle drawn from the heating furnace or the like, or can also be determined by the ratio between the lengths of the carbon material precursor fiber bundle and the thermally-stabilized fiber bundle (the length of the thermally-stabilized fiber bundle/the length of the carbon material precursor fiber bundle). Such a draw ratio can be controlled by adjusting the ratio (drawing speed/introducing speed) between the feeding speeds of the carbon material precursor fiber bundle and the thermally-stabilized fiber bundle as well as the tension applied to the fiber bundle, the temperature during the drawing process, the water content of the acrylamide-based polymer fiber, and the like. However, even when, for example, the temperature during the drawing process and the water content of the acrylamide-based polymer fiber are the same, the draw ratio changes depending on the composition of the acrylamide-based polymer, the presence or absence of the additive in the acrylamide-based polymer fiber, and the amount added thereof, and thus it is necessary to adjust to the desired draw ratio by adjusting the ratio (drawing speed/introducing speed) between the feeding speeds of the carbon material precursor fiber bundle and the thermally-stabilized fiber bundle as well as the tension applied to the fiber bundle (controlled by a weight, a spring, and the like).

As described above, in the present invention, when the carbon fiber precursor fiber bundle is subjected to thermally-stabilizing treatment, the thermally-stabilized fiber bundle of the present invention is obtained containing single fibers in a proportion having a circular cross section in the range of 30 to 100%, wherein the circular cross section has a ratio of a major axis to a minor axis of 1.0 to 1.3 in a cross section orthogonal to a longitudinal direction of the single fiber, and a fineness of the single fiber is in the range of 0.1 to 6 dtex. When the thermally-stabilized fiber bundle in which the proportion of single fibers having a circular cross-sectional shape is in the above range is subjected to carbonizing treatment, a carbon fiber bundle having a high tensile modulus is obtained. In contrast, even if the carbon fiber precursor fiber bundle in which the proportion of single fibers having a circular cross-sectional shape is less than the lower limit is subjected to thermally-stabilizing treatment, the tensile modulus is not sufficiently improved in the obtained carbon fiber bundle. In addition, the proportion of single fibers having a circular cross-sectional shape is preferably 35 to 100%, more preferably 40 to 100%, and particularly preferably 50 to 100%, from the viewpoint that a carbon fiber bundle having a high tensile modulus is obtained.

In addition, in the thermally-stabilized fiber bundle, when the fineness of the single fiber is within the above range, a carbon fiber bundle having excellent tensile modulus is obtained. In contrast, if the fineness of the single fiber is less than the lower limit, yarn breakage is likely to occur, and stable winding and carbonizing treatment become difficult. On the other hand, if the fineness of the single fiber exceeds the upper limit, the tensile modulus of the obtained carbon fiber bundle tends to decrease. In addition, the fineness of the single fiber is preferably 0.15 to 6 dtex, more preferably 0.2 to 5 dtex, and particularly preferably 0.25 to 4 dtex, from the viewpoint that the tensile modulus of the obtained carbon fiber bundle is improved and the occurrence of yarn breakage and fluffing during carbonizing treatment is suppressed.

Further, in the thermally-stabilized fiber bundle of the present invention, the average fiber diameter of the single fiber is not particularly limited, but is preferably 1 to 50 μm, more preferably 2 to 40 μm, further preferably 3 to 30 μm, particularly preferably 4 to 25 μm, and most preferably 5 to 20 μm. If the average fiber diameter of the single fiber of the thermally-stabilized fiber bundle is less than the lower limit, yarn breakage is likely to occur, and stable winding and carbonizing treatment tend to become difficult. On the other hand, if the average fiber diameter of the single fiber of the thermally-stabilized fiber bundle exceeds the upper limit, in the obtained single fiber of the carbon fiber bundle, the structure is significantly different between the vicinity of the surface layer and the vicinity of the center, and the tensile strength and tensile modulus tend to decrease.

In addition, the thermally-stabilized fiber bundle of the present invention preferably has an absorption peak derived from a polycyclic structure within the range of 1560 to 1595 cm-1 in the infrared absorption spectrum. The thermally-stabilized fiber bundle having such an absorption peak has high heat resistance and a high carbonization yield. Further, in the thermally-stabilized fiber bundle, the ratio (I_{A}/I_{B}) of the intensity (I_{A}) of the absorption peak observed in the range of 1560 to 1595 cm⁻¹ to the intensity (I_{B}) of the absorption peak derived from the amide group of the acrylamide polymer observed near 1648 cm⁻¹ is preferably 0.1 to 20, and preferably 0.5 to 10. A thermally-stabilized fiber bundle having I_{A}/I_{B} within the above range has high heat resistance and carbonization yield.

### [Method for Producing Carbon Fiber Bundle]

Next, the method for producing a carbon fiber bundle of the present invention is described. The method for producing a carbon fiber bundle of the present invention is a method including subjecting the thermally-stabilized fiber bundle of the present invention to heating treatment (carbonizing treatment) in an inert atmosphere (in an inert gas such as nitrogen, argon, helium, or xenon) at a temperature higher than the temperature during the thermally-stabilizing treatment. As a result, the thermally-stabilized fiber bundle is carbonized, and a desired carbon fiber bundle is obtained. The heating temperature (maximum temperature) in such carbonizing treatment is preferably 1000° C. or more, more preferably 1100° C. or more, further preferably 1200° C. or more, and particularly preferably 1300° C. or more. In addition, the upper limit of the heating temperature is preferably 3000° C. or less, more preferably 2500° C. or less, and further preferably 2000° C. or less. Note that the “carbonizing treatment” according to the present invention may include a “graphitization treatment” generally performed by heating at 2000 to 3000° C. in an inert gas atmosphere. The heating time in the carbonizing treatment is not particularly limited, but is preferably 30 seconds to 60 minutes, and more preferably 1 to 30 minutes.

Further, in the method for producing a carbon fiber bundle of the present invention, it is preferable to perform heating treatment (pre-carbonizing treatment) at a temperature of less than 1000° C. before the carbonizing treatment. Further, the pre-carbonizing treatment may be performed while subjecting the thermally-stabilized fiber bundle to drawing process.

Further, in the method for producing a carbon fiber bundle of the present invention, it is possible to perform heating treatment multiple times, for example the thermally-stabilized fiber bundle is subjected to the pre-carbonizing treatment, then the carbonizing treatment, and further the graphitization treatment.

In the carbon fiber bundle thus obtained, the average fiber diameter of the single fiber is not particularly limited, but is preferably 1 to 50 μm, more preferably 2 to 40 μm, further preferably 3 to 30 μm, particularly preferably 4 to 25 μm, and most preferably 5 to 20 μm. If the average fiber diameter of the single fiber of the carbon fiber bundle is less than the lower limit, in a case where a composite material is prepared using a resin or the like as a matrix, a high viscosity of the matrix may cause insufficient impregnation of the resin or the like into the carbon fiber bundle, which may reduce the tensile strength of the composite material. On the other hand, if the average fiber diameter of the single fiber of the carbon fiber bundle exceeds the upper limit, the tensile strength and tensile modulus of the carbon fiber bundle tend to decrease.

Further, in the method for producing a carbon fiber bundle of the present invention, it is preferable to subject the carbon fiber bundle to an electrolytic treatment in order to modify the surface of the carbon fiber bundle and optimize the adhesion to the resin. As a result, the problems of the carbon fiber bundle are solved, such as when a composite material with a resin is formed, the composite material is brittlely broken due to strong adhesion, the tensile strength in the fiber axis direction is lowered, and the strength characteristics in the direction perpendicular to the fiber axis direction are not exhibited, and a composite material is obtained in which the strength characteristics are balanced in the fiber axis direction and the direction perpendicular thereto.

Examples of the electrolytic solution used in the electrolytic treatment include an aqueous solution containing an acid, an alkali, or a salt thereof. Examples of the acid include sulfuric acid, nitric acid, and hydrochloric acid, and examples of the alkali include sodium hydroxide, potassium hydroxide, tetraethylammonium hydroxide, ammonium carbonate, and ammonium hydrogencarbonate.

Further, the carbon fiber bundle subjected to the electrolytic treatment may be washed with water to remove the electrolytic solution, subjected to drying treatment, and then given a sizing agent in order to improve the adhesion with a resin. As such a sizing agent, a compound having multiple reactive functional groups is preferable. The reactive functional groups are not particularly limited, but are preferably functional groups capable of reacting with a carboxy group or a hydroxyl group, and more preferably epoxy groups. In the sizing agent, the number of the reactive functional groups present in one molecule of the compound is preferably 2 to 6, more preferably 2 to 4, and particularly preferably 2. If the number of the reactive functional groups is one, the adhesion between the carbon fiber bundle and the resin tends not to be improved. On the other hand, if the number of the reactive functional groups exceeds the upper limit, the intermolecular crosslink density of the compound constituting the sizing agent increases, the layer formed by the sizing agent becomes brittle, and the tensile strength of the composite material of the carbon fiber bundle and the resin tends to decrease.

### EXAMPLES

Hereinafter, the present invention is described in more detail based on Examples and Comparative Examples, but the present invention is not limited to the following Examples. Note that the acrylamide-based polymer and each acrylamide-based polymer fiber used in Examples and Comparative Examples were prepared by the following methods.

### Preparation Example 1

### <Synthesis of Acrylamide/Acrylonitrile Copolymer>

To 400 parts by mass of deionized water, 100 parts by mass of a monomer composed of 75 mol % of acrylamide (AM) and 25 mol % of acrylonitrile (AN) and 4.36 parts by mass of tetramethylethylenediamine were dissolved, and to the obtained aqueous solution, 3.43 parts by mass of ammonium persulfate was added while stirring under a nitrogen atmosphere, and then the mixture was heated at 70° C. for 150 minutes, and subsequently the temperature was raised to 90° C. over 30 minutes, and after that the mixture was heated at 90° C. for 1 hour to perform a polymerization reaction. The obtained aqueous solution was added dropwise to methanol to precipitate a copolymer, which was collected and vacuum dried at 80° C. for 12 hours to obtain a water-soluble acrylamide/acrylonitrile copolymer (AM/AN copolymer).

### <Measurement of Composition Ratio of AM/AN Copolymer>

The obtained AM/AN copolymer was dissolved in heavy water, and the obtained aqueous solution was subjected to ¹³C-NMR measurement under the conditions of room temperature and a frequency of 100 MHz. In the obtained ¹³C-NMR spectrum, based on the integrated intensity ratio between the carbon-derived peak of the carbonyl group of the acrylamide appearing at about 177 ppm to about 182 ppm and the carbon-derived peak of the cyano group of the acrylonitrile appearing at about 121 ppm to about 122 ppm, the molar ratio (AM/AN) of the acrylamide (AM) unit and the acrylonitrile (AN) unit in the AM/AN copolymer was determined, and it was found that AM/AN=75 mol %/25 mol %.

### Preparation Example 2

### <Synthesis of Acrylamide/Acrylonitrile/Acrylic Acid Copolymer>

To 566.7 parts by mass of deionized water, 100 parts by mass of a monomer composed of 73 mol % of acrylamide (AM), 25 mol % of acrylonitrile (AN), and 2 mol % of acrylic acid (AA) and 4.36 parts by mass of tetramethylethylenediamine were dissolved, and to the obtained aqueous solution, 3.43 parts by mass of ammonium persulfate was added while stirring under a nitrogen atmosphere, and then the mixture was heated at 70° C. for 150 minutes, and subsequently the temperature was raised to 90° C. over 30 minutes, and after that the mixture was heated at 90° C. for 1 hour to perform a polymerization reaction. The obtained aqueous solution was added dropwise to methanol to precipitate a copolymer, which was collected and vacuum dried at 80° C. for 12 hours to obtain a water-soluble acrylamide/acrylonitrile/acrylic acid copolymer (AM/AN/AA copolymer).

### <Measurement of Composition Ratio of AM/AN/AA Copolymer>

The obtained AM/AN/AA copolymer was dissolved in heavy water, and the obtained aqueous solution was subjected to ¹³C-NMR measurement under the conditions of room temperature and a frequency of 100 MHz. In the obtained ¹³C-NMR spectrum, based on the integrated intensity ratio among the carbon-derived peak of the carbonyl group of the acrylamide appearing at about 177 ppm to about 182 ppm, the carbon-derived peak of the cyano group of the acrylonitrile appearing at about 121 ppm to about 122 ppm, and the carbon-derived peak of the carbonyl group of the acrylic acid appearing at about 179 ppm to about 182 ppm, the molar ratio ((AM+AA)/AN) of acrylamide (AM) units and acrylic acid (AA) units to acrylonitrile (AN) units in the AM/AN/AA copolymer was calculated.

In addition, the AM/AN/AA copolymer was subjected to infrared spectroscopic analysis (IR), and in the obtained IR spectrum, based on the intensity ratio between the peak derived from the acrylamide (AM) appearing at about 1678 cm⁻¹, the peak derived from the acrylonitrile (AN) appearing at about 2239 cm⁻¹, and the peak derived from acrylic acid (AA) appearing at about 1715 cm⁻¹, the molar ratio (AM/AA) of the acrylamide (AM) units and the acrylic acid (AA) units in the AM/AN/AA copolymer was calculated.

The above-described (AM+AA)/AN and the AM/AA were used to determine the molar ratio (AM/AN/AA) among the acrylamide (AM) units, the acrylonitrile (AN) units, and the acrylic acid (AA) units in the AM/AN/AA copolymer, and it was found that AM/AN/AA=73 mol %/25 mol %/2 mol %.

### Preparation Example 3

### <Synthesis of Acrylamide/Acrylonitrile/Acrylic Acid Copolymer and Measurement of Composition Ratio>

A water-soluble acrylamide/acrylonitrile/acrylic acid copolymer (AM/AN/AA copolymer) was obtained in the same manner as in Preparation Example 2 except for using 100 parts by mass of a monomer composed of 65 mol % of acrylamide (AM), 33 mol % of acrylonitrile (AN), and 2 mol % of acrylic acid (AA) as the monomer. When the composition ratio of this AM/AN/AA copolymer was measured in the same manner as in Preparation Example 2, it was found that was AM/AN/AA=65 mol %/33 mol %/2 mol %.

### Preparation Example 4

### <Synthesis of Acrylamide Homopolymer>

To 2912 parts by mass of distilled water, 100 parts by mass of acrylamide (AM) and 8.78 parts by mass of tetramethylethylenediamine were dissolved, and to the obtained aqueous solution, 1.95 parts by mass of ammonium persulfate was added while stirring under a nitrogen atmosphere, followed by a polymerization reaction at 60° C. for 3 hours. The obtained aqueous solution was added dropwise to methanol to precipitate a homopolymer, which was collected and vacuum dried at 80° C. for 12 hours to obtain a water-soluble acrylamide homopolymer (PAM, AM=100 mol %).

### Production Example 1

### <Production of Acrylamide-Based Polymer Fiber>

The AM/AN copolymer (AM/AN=75 mol %/25 mol %) obtained in Preparation Example 1 was dissolved in deionized water, and the obtained aqueous solution was used to perform dry spinning so that the fineness of the acrylamide-based polymer fiber was about 3 dtex/fiber and the average fiber diameter was about 17 μm, thereby preparing an acrylamide-based polymer fiber (f-1). When the fineness and the average fiber diameter of this acrylamide-based polymer fiber (f-1) were measured by the following methods, the fineness was 3.3 dtex/fiber, and the average fiber diameter was 18 μm.

### <Fineness of Acrylamide-Based Polymer Fiber>

One hundred acrylamide-based polymer fibers obtained were bundled to produce an acrylamide-based polymer fiber bundle (100 fibers/bundle), and the mass of this fiber bundle at the time of absolute drying or after drying at 120° C. for 2 hours was measured, and the fineness of the fiber bundle was calculated by the following formula:

$$Fineness of Fiber Bundle [ dtex ] = Mass of Fiber Bundle [ g ] / Fiber \\ \\ Length [ m ] \times 10000 [ m ]$$

and the fineness of the single fibers constituting the fiber bundle (the fineness of the acrylamide-based polymer fiber) was determined.

### <Average Fiber Diameter of Acrylamide-Based Polymer Fiber>

The density of the acrylamide-based polymer fiber bundle was measured using a dry automatic densitometer (“AccuPyc II 1340” manufactured by Micromeritics Instrument Corporation), and the average fiber diameter of the single fibers constituting the fiber bundle (the average fiber diameter of the acrylamide-based polymer fiber) was determined by the following formula:

$$D = {\{ ( D t \times 4 \times 1 \; 00 ) / ( ρ \times Π \times n ) \}}^{1 / 2}$$

[in the formula, D represents the average fiber diameter [μm] of the single fibers constituting the fiber bundle, Dt represents the fineness [dtex] of the fiber bundle, p represents the density [g/cm³] of the fiber bundle, and n represents the number [fibers] of the single fibers constituting the fiber bundle].

### <Production of Acrylamide-Based Polymer Fiber Bundle>

One thousand five hundred fiber bundles of the acrylamide-based polymer fibers (f-1) were bundled to produce a fiber bundle (1500 fibers/bundle). When the shape of the cross section of each single fiber of this fiber bundle was observed by the following method, the proportion of single fibers having a circular cross section (proportion of circular shape) was 0%, and the proportion of single fibers having an elliptical cross section (proportion of elliptical shape) was 100%.

### <Shape Observation of Cross Sections of Single Fibers of Acrylamide-Based Polymer Fiber Bundle>

The cross section of the acrylamide-based polymer fiber bundle was observed using a microscope (“Digital Microscope VHX-7000” manufactured by KEYENCE CORPORATION), and 20 cross sections of single fibers were randomly extracted. Among these 20 cross sections of single fibers, the proportion of circular cross sections (proportion of circular shape) in which the ratio of the major axis to the minor axis was 1.0 to 1.3 was determined, and the proportion of elliptical cross sections (proportion of elliptical shape) in which the ratio of the major axis to the minor axis exceeded 1.3 was determined.

### Production Example 2

The AM/AN copolymer (AM/AN=75 mol %/25 mol %) obtained in Preparation Example 1 was dissolved in deionized water, and to the obtained aqueous solution, 3 parts by mass of phosphoric acid relative to 100 parts by mass of the AM/AN copolymer was added to completely dissolve it. The obtained aqueous solution was used to perform dry spinning so that the fineness of the acrylamide-based polymer fiber was about 3 dtex/fiber and the average fiber diameter was about 17 μm, thereby preparing an acrylamide-based polymer fiber (f-2). When the fineness and the average fiber diameter of this acrylamide-based polymer fiber (f-2) were measured in the same manner as in Production Example 1, the fineness was 3.8 dtex/fiber, and the average fiber diameter was 20 μm.

Next, in the same manner as in Production Example 1, a fiber bundle (1500 fibers/bundle) of the acrylamide-based polymer fibers (f-2) was produced, and the shape of the cross section of each single fiber was observed. The proportion of single fibers having a circular cross section (proportion of circular shape) was 0%, and the proportion of single fibers having an elliptical cross section (proportion of elliptical shape) was 100%.

### Production Example 3

An acrylamide-based polymer fiber (f-3) was produced in the same manner as in Production Example 1 except that the AM/AN/AA copolymer (AM/AN/AA=73 mol %/25 mol %/2 mol %) obtained in Preparation Example 2 was used instead of the AM/AN copolymer (AM/AN=75 mol %/25 mol %) obtained in Preparation Example 1 and that dry spinning was performed so that the fineness of the acrylamide-based polymer fiber was about 6 dtex/fiber and the average fiber diameter was about 25 μm. When the fineness and the average fiber diameter of this acrylamide-based polymer fiber (f-3) were measured in the same manner as in Production Example 1, the fineness was 5.7 dtex/fiber, and the average fiber diameter was 24 μm.

Next, in the same manner as in Production Example 1, a fiber bundle (1500 fibers/bundle) of the acrylamide-based polymer fibers (f-3) was produced, and the shape of the cross section of each single fiber was observed. The proportion of single fibers having a circular cross section (proportion of circular shape) was 0%, and the proportion of single fibers having an elliptical cross section (proportion of elliptical shape) was 100%.

### Production Example 4

An acrylamide-based polymer fiber (f-4) was produced in the same manner as in Production Example 2 except that the AM/AN/AA copolymer (AM/AN/AA=73 mol %/25 mol %/2 mol %) obtained in Preparation Example 2 was used instead of the AM/AN copolymer (AM/AN=75 mol %/25 mol %) obtained in Preparation Example 1 and that dry spinning was performed so that the fineness of the acrylamide-based polymer fiber was about 6 dtex/fiber and the average fiber diameter was about 25 μm. When the fineness and the average fiber diameter of this acrylamide-based polymer fiber (f-4) were measured in the same manner as in Production Example 1, the fineness was 6.8 dtex/fiber, and the average fiber diameter was 26 μm.

Next, in the same manner as in Production Example 1, a fiber bundle (1500 fibers/bundle) of the acrylamide-based polymer fibers (f-4) was produced, and the shape of the cross section of each single fiber was observed. The proportion of single fibers having a circular cross section (proportion of circular shape) was 0%, and the proportion of single fibers having an elliptical cross section (proportion of elliptical shape) was 100%.

### Production Example 5

An acrylamide-based polymer fiber (f-5) was produced in the same manner as in Production Example 1 except that the AM/AN/AA copolymer (AM/AN/AA=65 mol %/33 mol %/2 mol %) obtained in Preparation Example 3 was used instead of the AM/AN copolymer (AM/AN=75 mol %/25 mol %) obtained in Preparation Example 1 and that dry spinning was performed so that the fineness of the acrylamide-based polymer fiber was about 4 dtex/fiber and the average fiber diameter was about 20 μm. When the fineness and the average fiber diameter of this acrylamide-based polymer fiber (f-5) were measured in the same manner as in Production Example 1, the fineness was 4.2 dtex/fiber, and the average fiber diameter was 21 μm.

Next, in the same manner as in Production Example 1, a fiber bundle (1500 fibers/bundle) of the acrylamide-based polymer fibers (f-5) was produced, and the shape of the cross section of each single fiber was observed. The proportion of single fibers having a circular cross section (proportion of circular shape) was 10%, and the proportion of single fibers having an elliptical cross section (proportion of elliptical shape) was 90%.

### Production Example 6

An acrylamide-based polymer fiber (f-6) was produced in the same manner as in Production Example 2 except that the AM/AN/AA copolymer (AM/AN/AA=65 mol %/33 mol %/2 mol %) obtained in Preparation Example 3 was used instead of the AM/AN copolymer (AM/AN=75 mol %/25 mol %) obtained in Preparation Example 1 and that dry spinning was performed so that the fineness of the acrylamide-based polymer fiber was about 2 dtex/fiber and the average fiber diameter was about 14 μm. When the fineness and the average fiber diameter of this acrylamide-based polymer fiber (f-6) were measured in the same manner as in Production Example 1, the fineness was 2.3 dtex/fiber, and the average fiber diameter was 15 μm.

Next, in the same manner as in Production Example 1, a fiber bundle (1500 fibers/bundle) of the acrylamide-based polymer fibers (f-6) was produced, and the shape of the cross section of each single fiber was observed. The proportion of single fibers having a circular cross section (proportion of circular shape) was 20%, and the proportion of single fibers having an elliptical cross section (proportion of elliptical shape) was 80%.

### Production Example 7

An acrylamide-based polymer fiber (f-7) was produced in the same manner as in Production Example 6 except that 3 parts by mass of diammonium hydrogen phosphate was added to 100 parts by mass of the AM/AN/AA copolymer instead of phosphoric acid. When the fineness and the average fiber diameter of this acrylamide-based polymer fiber (f-7) were measured in the same manner as in Production Example 1, the fineness was 2.0 dtex/fiber, and the average fiber diameter was 14 μm.

Next, in the same manner as in Production Example 1, a fiber bundle (1500 fibers/bundle) of the acrylamide-based polymer fibers (f-7) was produced, and the shape of the cross section of each single fiber was observed. The proportion of single fibers having a circular cross section (proportion of circular shape) was 20%, and the proportion of single fibers having an elliptical cross section (proportion of elliptical shape) was 80%.

### Production Example 8

An acrylamide-based polymer fiber (f-8) was produced in the same manner as in Production Example 1 except that the PAM (AM=100 mol %) obtained in Preparation Example 4 was used instead of the AM/AN copolymer (AM/AN=75 mol %/25 mol %) obtained in Preparation Example 1 and that dry spinning was performed so that the fineness of the acrylamide-based polymer fiber was about 3 dtex/fiber and the average fiber diameter was about 20 μm. When the fineness and the average fiber diameter of this acrylamide-based polymer fiber (f-8) were measured in the same manner as in Production Example 1, the fineness was 4.0 dtex/fiber, and the average fiber diameter was 20 μm.

Next, one thousand two hundred fiber bundles of the acrylamide-based polymer fibers (f-8) were bundled to produce a fiber bundle (1200 fibers/bundle). When the shape of the cross section of each single fiber of this fiber bundle was observed in the same manner as in Production Example 1, the proportion of single fibers having a circular cross section (proportion of circular shape) was 0%, and the proportion of single fibers having an elliptical cross section (proportion of elliptical shape) was 100%.

### Example 1

The fiber bundles (1500 fibers/bundle) of the acrylamide-based polymer fibers (f-1) obtained in Production Example 1 were drawn at a draw ratio of 4 in an air atmosphere at a temperature of 260° C. to produce carbon fiber precursor fiber bundles (1500 fibers/bundle).

The obtained carbon fiber precursor fiber bundles (1500 fibers/bundle) were combined to produce precursor fiber bundles of 12000 fibers/bundle, and these precursor fiber bundles (12000 fibers/bundle) were subjected to heating treatment (thermally-stabilizing treatment) at 350° C. (thermally-stabilizing treatment temperature (maximum temperature during the thermally-stabilizing treatment)) for 30 minutes in an air atmosphere to produce thermally-stabilized fiber bundles (12000 fibers/bundle).

The obtained thermally-stabilized fiber bundles (12000 fibers/bundle) were moved in a nitrogen atmosphere having a temperature gradient of 300° C. to 800° C. over 3 minutes to perform heating treatment (pre-carbonizing treatment), and then moved in a nitrogen atmosphere having a temperature gradient of 1300° C. to 1700° C. over 3 minutes to perform heating treatment (carbonizing treatment) to produce carbon fiber bundles (12000 fibers/bundle).

### Example 2

Carbon fiber precursor fiber bundles (1500 fibers/bundle), thermally-stabilized fiber bundles (12000 fibers/bundle), and carbon fiber bundles (12000 fibers/bundle) were produced in the same manner as in Example 1 except that the temperature during drawing was changed to 250° C., the draw ratio was changed to 2, and the temperature gradient during carbonizing treatment was changed to a temperature gradient of 1000° C. to 1350° C.

### Example 3

Carbon fiber precursor fiber bundles (1500 fibers/bundle), thermally-stabilized fiber bundles (12000 fibers/bundle), and carbon fiber bundles (12000 fibers/bundle) were produced in the same manner as in Example 1 except that the fiber bundles (1500 fibers/bundle) of the acrylamide-based polymer fibers (f-2) obtained in Production Example 2 were used instead of the fiber bundles (1500 fibers/bundle) of the acrylamide-based polymer fibers (f-1) obtained in Production Example 1.

### Example 4

Carbon fiber precursor fiber bundles (1500 fibers/bundle), thermally-stabilized fiber bundles (12000 fibers/bundle), and carbon fiber bundles (12000 fibers/bundle) were produced in the same manner as in Example 1 except that the fiber bundles (1500 fibers/bundle) of the acrylamide-based polymer fibers (f-3) obtained in Production Example 3 were used instead of the fiber bundles (1500 fibers/bundle) of the acrylamide-based polymer fibers (f-1) obtained in Production Example 1.

### Example 5

Carbon fiber precursor fiber bundles (1500 fibers/bundle), thermally-stabilized fiber bundles (12000 fibers/bundle), and carbon fiber bundles (12000 fibers/bundle) were produced in the same manner as in Example 1 except that the fiber bundles (1500 fibers/bundle) of the acrylamide-based polymer fibers (f-4) obtained in Production Example 4 were used instead of the fiber bundles (1500 fibers/bundle) of the acrylamide-based polymer fibers (f-1) obtained in Production Example 1.

### Example 6

Carbon fiber precursor fiber bundles (1500 fibers/bundle), thermally-stabilized fiber bundles (12000 fibers/bundle) were produced in the same manner as in Example 5 except that the draw ratio was changed to 6.

### Example 7

Carbon fiber precursor fiber bundles (1500 fibers/bundle), thermally-stabilized fiber bundles (12000 fibers/bundle), and carbon fiber bundles (12000 fibers/bundle) were produced in the same manner as in Example 1 except that the fiber bundles (1500 fibers/bundle) of the acrylamide-based polymer fibers (f-5) obtained in Production Example 5 were used instead of the fiber bundles (1500 fibers/bundle) of the acrylamide-based polymer fibers (f-1) obtained in Production Example 1.

### Example 8

Carbon fiber precursor fiber bundles (1500 fibers/bundle), thermally-stabilized fiber bundles (12000 fibers/bundle), and carbon fiber bundles (12000 fibers/bundle) were produced in the same manner as in Example 1 except that the fiber bundles (1500 fibers/bundle) of the acrylamide-based polymer fibers (f-6) obtained in Production Example 6 were used instead of the fiber bundles (1500 fibers/bundle) of the acrylamide-based polymer fibers (f-1) obtained in Production Example 1.

### Example 9

Carbon fiber precursor fiber bundles (1500 fibers/bundle), thermally-stabilized fiber bundles (12000 fibers/bundle) were produced in the same manner as in Example 8 except that the draw ratio was changed to 2.5.

### Example 10

Carbon fiber precursor fiber bundles (1500 fibers/bundle), thermally-stabilized fiber bundles (12000 fibers/bundle), and carbon fiber bundles (12000 fibers/bundle) were produced in the same manner as in Example 1 except that the fiber bundles (1500 fibers/bundle) of the acrylamide-based polymer fibers (f-7) obtained in Production Example 7 were used instead of the fiber bundles (1500 fibers/bundle) of the acrylamide-based polymer fibers (f-1) obtained in Production Example 1.

### Example 11

Carbon fiber precursor fiber bundles (1200 fibers/bundle), thermally-stabilized fiber bundles (12000 fibers/bundle), and carbon fiber bundles (12000 fibers/bundle) were produced in the same manner as in Example 1 except that the fiber bundles (1200 fibers/bundle) of the acrylamide-based polymer fibers (f-8) obtained in Production Example 8 were used instead of the fiber bundles (1500 fibers/bundle) of the acrylamide-based polymer fibers (f-1) obtained in Production Example 1, the draw ratio was changed to 2.5, and the temperature gradient during carbonizing treatment was changed to a temperature gradient of 1000° C. to 1350° C.

### Comparative Example 1

Carbon fiber precursor fiber bundles (1500 fibers/bundle), thermally-stabilized fiber bundles (12000 fibers/bundle), and carbon fiber bundles (12000 fibers/bundle) were produced in the same manner as in Example 1 except that the temperature during drawing was changed to 190° C. and the draw ratio was changed to 1.5. Note that in the obtained carbon fiber precursor fiber bundles and thermally-stabilized fiber bundles, some of the fibers were broken.

### Comparative Example 2

Carbon fiber precursor fiber bundles (1500 fibers/bundle), thermally-stabilized fiber bundles (12000 fibers/bundle), and carbon fiber bundles (12000 fibers/bundle) were produced in the same manner as in Example 3 except that the temperature during drawing was changed to 190° C. and the draw ratio was changed to 1.5. Note that in the obtained carbon fiber precursor fiber bundles and thermally-stabilized fiber bundles, some of the fibers were broken.

### Comparative Example 3

Carbon fiber precursor fiber bundles (1500 fibers/bundle), thermally-stabilized fiber bundles (12000 fibers/bundle), and carbon fiber bundles (12000 fibers/bundle) were produced in the same manner as in Example 4 except that the temperature during drawing was changed to 190° C. and the draw ratio was changed to 1.5. Note that in the obtained carbon fiber precursor fiber bundles and thermally-stabilized fiber bundles, some of the fibers were broken.

### Comparative Example 4

Carbon fiber precursor fiber bundles (1200 fibers/bundle), thermally-stabilized fiber bundles (12000 fibers/bundle), and carbon fiber bundles (12000 fibers/bundle) were produced in the same manner as in Example 11 except that the temperature during drawing was changed to 190° C. and the draw ratio was changed to 1.5. Note that in the obtained carbon fiber precursor fiber bundles and thermally-stabilized fiber bundles, some of the fibers were broken.

### <Shape Observation of Cross Sections of Single Fibers of Carbon Fiber Precursor Fiber Bundle and Thermally-Stabilized Fiber Bundle>

The cross sections of the obtained carbon fiber precursor fiber bundle and thermally-stabilized fiber bundle were observed using a microscope (“Digital Microscope VHX-7000” manufactured by KEYENCE CORPORATION), and 20 cross sections of single fibers were randomly extracted. Among these 20 cross sections of single fibers, the proportion of circular cross sections (proportion of circular shape) in which the ratio of the major axis to the minor axis was 1.0 to 1.3 was determined. Table 2 shows the results.

### <Fineness of Carbon Fiber Precursor Fibers and Thermally-Stabilized Fibers>

The masses of the obtained carbon fiber precursor fiber bundle and thermally-stabilized fiber bundle at the time of absolute drying or after drying at 120° C. for 2 hours were measured, and the fineness of the fiber bundles was calculated by the following formula:

$$Fineness of Fiber Bundle [ dtex ] = Mass of Fiber Bundle [ g ] / Fiber Length [ m ] \times 10000 [ m ]$$

and the fineness of the single fibers constituting the fiber bundles (the fineness of the carbon fiber precursor fiber and the thermally-stabilized fiber) was determined. Table 2 shows the results.

### <Average Fiber Diameters of Carbon Fiber Precursor Fiber, Thermally-Stabilized Fiber, and Carbon Fiber>

Regarding the obtained carbon fiber precursor fiber bundle, thermally-stabilized fiber bundle, and carbon fiber bundle, side surface was observed using a microscope (“Digital Microscope VHX-1000” manufactured by KEYENCE CORPORATION), and a measurement point of the fiber diameter of each of the 10 randomly extracted single fibers was randomly selected to measure the fiber diameters of the carbon fiber precursor fibers constituting the carbon fiber precursor fiber bundle, the thermally-stabilized single fibers constituting the thermally-stabilized fiber bundle, and the carbon fibers constituting the carbon fiber bundle, and the average values (average fiber diameters of carbon fiber precursor fibers, thermally-stabilized fibers, and carbon fibers) was determined. Table 2 shows the results.

### <Tensile Modulus of Carbon Fiber>

Single fibers are taken out from the obtained carbon fiber bundle, and a micro strain tester (“Micro Autograph MST-I” manufactured by Shimadzu Corporation) was used to perform a tensile test (gauge length: 25 mm, and tensile speed: 1 mm/min) at room temperature in accordance with JIS R7606, measure the tensile modulus, and obtain the average value of 10 times. Table 2 shows the results.

TABLE 1

| | Acrylamide-Based Polymer Fiber Bundle | | | | | | Drawing Process Condition | |
|---|---|---|---|---|---|---|---|---|
| | | | Single-Fiber | Average | Proportion of | Proportion of | Draw | |
| | Composition | Addition Component | Fineness | Fiber Diameter | Circular Shape | Elliptic Shape | Temperature | Draw Ratio |
| | AM/AN/AA | (Addition Amount*¹) | [dtex] | [μm] | [%] | [%] | [° C.] | [Times] |
| Ex. 1 | 75/25/0 | None | 3.3 | 18 | 0 | 100 | 260 | 4 |
| Ex. 2 | 75/25/0 | None | 3.3 | 18 | 0 | 100 | 250 | 2 |
| Ex. 3 | 75/25/0 | Phosphoric Acid (3) | 3.8 | 20 | 0 | 100 | 260 | 4 |
| Ex. 4 | 73/25/2 | None | 5.7 | 24 | 0 | 100 | 260 | 4 |
| Ex. 5 | 73/25/2 | Phosphoric Acid (3) | 6.8 | 26 | 0 | 100 | 260 | 4 |
| Ex. 6 | 73/25/2 | Phosphoric Acid (3) | 6.8 | 26 | 0 | 100 | 260 | 6 |
| Ex. 7 | 65/33/2 | None | 4.2 | 21 | 10 | 90 | 260 | 4 |
| Ex. 8 | 65/33/2 | Phosphoric Acid (3) | 2.3 | 15 | 20 | 80 | 260 | 4 |
| Ex. 9 | 65/33/2 | Phosphoric Acid (3) | 2.3 | 15 | 20 | 80 | 260 | 2.5 |
| Ex. 10 | 65/33/2 | Phosphate*² (3) | 2.0 | 14 | 20 | 80 | 260 | 4 |
| Ex. 11 | 100/0/0 | None | 4.0 | 20 | 0 | 100 | 260 | 2.5 |
| Comp. Ex. 1 | 75/25/0 | None | 3.3 | 18 | 0 | 100 | 190 | 1.5 |
| Comp. Ex. 2 | 75/25/0 | Phosphoric Acid (3) | 3.8 | 20 | 0 | 100 | 190 | 1.5 |
| Comp. Ex. 3 | 73/25/2 | None | 5.7 | 24 | 0 | 100 | 190 | 1.5 |
| Comp. Ex. 4 | 100/0/0 | None | 4.0 | 20 | 0 | 100 | 190 | 1.5 |

*¹Amount [parts by mass] added to 100 parts by mass of polymer
*²Diammonium Hydrogen Phosphate

TABLE 2

| | Carbon Fiber Precursor Fiber Bundle | | | | Thermally-Stabilized Fiber Bundle | | | | Carbon Fiber | |
|---|---|---|---|---|---|---|---|---|---|---|
| | | | | Average | | | | Average | Average | |
| | | Proportion of | Single-Fiber | Fiber | | Proportion of | Single-Fiber | Fiber | Fiber | Tensile |
| | Fiber | Circular Shape | Fineness | Diameter | Fiber | Circular Shape | Fineness | Diameter | Diameter | Modulus |
| | Breakage | [%] | [dtex] | [μm] | Breakage | [%] | [dtex] | [μm] | [μm] | [GPa] |
| Ex. 1 | None | 40 | 0.8 | 9 | None | 40 | 0.7 | 8 | 6 | 205 |
| Ex. 2 | None | 30 | 1.6 | 13 | None | 30 | 1.4 | 11 | 8 | 111 |
| Ex. 3 | None | 45 | 1.0 | 10 | None | 45 | 0.9 | 9 | 7 | 222 |
| Ex. 4 | None | 55 | 1.4 | 12 | None | 55 | 0.9 | 9 | 7 | 230 |
| Ex. 5 | None | 60 | 1.6 | 13 | None | 60 | 1.1 | 10 | 7 | 301 |
| Ex. 6 | None | 90 | 1.0 | 10 | None | 95 | 0.7 | 8 | 6 | 348 |
| Ex. 7 | None | 55 | 1.0 | 10 | None | 55 | 0.7 | 8 | 6 | 220 |
| Ex. 8 | None | 80 | 0.6 | 8 | None | 85 | 0.4 | 6 | 5 | 320 |
| Ex. 9 | None | 35 | 1.0 | 10 | None | 35 | 0.9 | 9 | 7 | 198 |
| Ex. 10 | None | 80 | 0.5 | 7 | None | 80 | 0.4 | 6 | 5 | 311 |
| Ex. 11 | None | 30 | 1.4 | 12 | None | 30 | 1.1 | 10 | 8 | 101 |
| Comp. Ex. 1 | Partially | 0 | 2.0 | 14 | Partially | 0 | 1.4 | 11 | 8 | 63 |
| Comp. Ex. 2 | Partially | 0 | 2.2 | 15 | Partially | 0 | 1.9 | 13 | 10 | 65 |
| Comp. Ex. 3 | Partially | 5 | 2.5 | 16 | Partially | 5 | 1.9 | 13 | 10 | 71 |
| Comp. Ex. 4 | Partially | 0 | 2.2 | 15 | Partially | 0 | 1.6 | 12 | 9 | 62 |

As shown in Tables 1 and 2, it was confirmed that when a fiber bundle composed of acrylamide-based polymer fibers was subjected to a drawing process at a predetermined temperature and a predetermined draw ratio (Examples 1 to 11), a carbon fiber precursor fiber bundle and a thermally-stabilized fiber bundle containing single fibers having a circular cross section in a predetermined ratio could be obtained. Further, it was found that when a thermally-stabilized fiber bundle containing single fibers having a circular cross section at a predetermined ratio was subjected to a carbonizing treatment, a carbon fiber bundle having excellent tensile modulus could be obtained.

In contrast, it was found that when the temperature during the drawing process was lower than the predetermined temperature range (Comparative Examples 1 to 4), some fibers were broken during the drawing process. It was also found that in the obtained carbon fiber precursor fiber bundle, the proportion of single fibers having a circular cross section was small. Additionally, it was found that in such a carbon fiber precursor fiber bundle having a small proportion of single fibers having a circular cross section, some fibers were broken during the thermally-stabilizing treatment, and the fiber strength was inferior. It was also found that in the obtained thermally-stabilized fiber bundle, the proportion of single fibers having a circular cross section was small. Additionally, it was found that the carbon fiber bundle obtained by subjecting such a thermally-stabilized fiber bundle having a small proportion of single fibers having a circular cross section to a carbonizing treatment was inferior in tensile modulus.

Further, as shown in Table 2, when Example 1 and Example 2, Example 6 and Example 5, and Example 8 and Example 9 are compared, it is found that the higher the draw ratio is, the larger the proportion of single fibers having a circular cross section is in the obtained carbon fiber precursor fiber bundle and thermally-stabilized fiber bundle, and the tensile modulus of the carbon fiber bundle is improved.

As described above, the present invention makes it possible to obtain a carbon fiber precursor fiber bundle, in which the fiber strength is sufficiently improved by thermally-stabilizing treatment and the occurrence of yarn breakage during the thermally-stabilizing treatment is suppressed. In addition, when the carbon fiber precursor fiber bundle is subjected to thermally-stabilizing treatment and further carbonizing treatment, it is possible to obtain a carbon fiber bundle having a high tensile modulus.

Further, such a carbon fiber bundle is excellent in various properties such as light weight, rigidity, strength, elastic modulus, and corrosion resistance, and thus can be widely used as materials for various purposes such as aviation materials, space materials, automobile materials, pressure vessels, civil engineering and building materials, robot materials, communication equipment materials, medical materials, electronic materials, wearable materials, windmills, and sports equipment including golf shafts and fishing rods.

What is claimed is:

1. A method for producing a carbon fiber precursor fiber bundle, comprising:
subjecting a fiber bundle composed of acrylamide-based polymer fibers to a drawing process at a draw ratio of 1.3 to 100 at a temperature in a range of 225 to 320° C., to obtain the carbon fiber precursor fiber bundle of the acrylamide-based polymer fibers, wherein
the acrylamide-based polymer is selected from the group consisting of a homopolymer of an acrylamide-based monomer and a copolymer of 50 mol % or more of an acrylamide-based monomer and 50 mol % or less of an additional polymerizable monomer; and
the carbon fiber precursor fiber bundle contains single fibers having a circular cross section in a proportion of 30 to 100%, wherein the circular cross section has a ratio of a major axis to a minor axis of 1.0 to 1.3 in a cross section orthogonal to a longitudinal direction of the single fiber, and a fineness of the single fiber is 0.1 to 7 dtex.

2. The method for producing a carbon fiber precursor fiber bundle according to claim 1, wherein the draw ratio is 1.8 to 30.

3. A method for producing a thermally-stabilized fiber bundle, comprising:
subjecting the carbon fiber precursor fiber bundle produced by the method according to claim 1 to a thermally-stabilizing treatment, to obtain the thermally-stabilized fiber bundle of the acrylamide-based polymer fibers, wherein
the thermally-stabilized fiber bundle contains single fibers having a circular cross section in a proportion of 30 to 100%, wherein the circular cross section has a ratio of a major axis to a minor axis of 1.0 to 1.3 in a cross section orthogonal to a longitudinal direction of the single fiber, and a fineness of the single fiber is 0.1 to 6 dtex.

4. A method for producing a carbon fiber bundle, comprising:
subjecting the thermally-stabilized fiber bundle produced by the method according to claim 3 to a carbonizing treatment.
